(19) United States
(12) Patent Application Publication
(10) Pub. No.: US 2003/0136271 A1
(43) Pub. Date: Jul. 24, 2003

(54) Vegetable box for refrigerator

(75) Inventor: Dae-Yeon Kim, Pusan City (KR)

Correspondence Address: FLESHNER & KIM, LLP, P.O. Box 221200, Chantilly, VA, 20153-1200, US

(73) Assignee: LG Electronics Inc.

(21) Appl. No.: 10/348,760

(22) Filed: Jan. 23, 2003

(30) Foreign Application Priority Data
Jan. 23, 2002 (KR) 2002-3958
Jan. 23, 2002 (KR) 2002-3959

(51) Int. Cl. A01J 11/04; A23B 4/08

(52) U.S. Cl. 99/467; 99/517

(57) ABSTRACT

The present invention relates to a vegetable box for a refrigerator in which stored contents such as vegetables are stored. According to the present invention, a small quantity of foodstuffs can be easily put into and taken out from the vegetable box for the refrigerator. To this end, a receiving pocket 55 made of flexible material is installed in a box body 31 constructing the vegetable box 30. The box body 31 is provided with a support 37, which is connected to one side of the receiving pocket 55 for supporting the receiving pocket 55. A leading end of the box body 31 is provided with a front door 39, which is connected with the other side of the receiving pocket 55 and is opened while being inclined forward about hinge shafts 41 formed at lower portions of the box body by pressing of a button 43. The support 37 is formed transversely across an upper end of the leading end of the vegetable box 31. The support 37 is formed with a catching groove 53 in which a catching protrusion 49 of the button 43 is caught. According to the present invention, a small quantity of foodstuffs can be conveniently put into and taken out from the vegetable box, and required electric power can be reduced.

### BACKGROUND OF THE INVENTION

1. Field of the Invention

The present invention relates to a refrigerator, and more particularly, to a vegetable box for a refrigerator in which foodstuffs such as vegetables or fruit are stored.

2. Description of the Prior Art

FIG. 1 shows a configuration of a conventional vegetable box for a refrigerator. As shown in the figure, the vegetable box 20 is formed with a receiving space 21 which is open at the top. A rear surface 23 of the vegetable box 20 is formed in an inclined state to conform to a shape of a corresponding portion within the refrigerator. Side and front surfaces 25, 27 of the vegetable box 20 are formed perpendicular to a bottom surface of the vegetable box 20. At an upper end of a front surface of the vegetable box 20, a handle 29 is formed so that the vegetable box 20 can be slid out like a drawer.

Generally, vegetables or fruit are stored in the vegetable box 20. The vegetable box 20 is positioned, if possible, at a lower portion of the refrigerator far from an evaporator for producing cold air so that the vegetables or fruit are not frozen due to the cold air. Further, the vegetable box 20 is partitioned separately from a refrigerating chamber so that the cold air can be prevented from coming into direct contact with the vegetables or fruit. Furthermore, even when a refrigerator door is opened, by causing relatively warm air not to come into direct contact with the vegetables or fruit, the vegetables or fruit can be kept fresh for a long time.

However, the conventional vegetable box constructed as such has the following problems:

That is, in the conventional vegetable box, when a user intends to take a small quantity of fruit or vegetables out from or into the vegetable box, the user should open the refrigerator door, pull the entire vegetable box 20, take the stored fruit or vegetables out from or into the vegetable box, and then push the entire vegetable box 20.

Accordingly, in a case where a large quantity of contents are stored in the vegetable box 20, large force is required to pull the vegetable box 20. Further, since the receiving space 21 of the pulled vegetable box 20 is exposed to the relatively warm air, it is difficult to keep the contents fresh. Moreover, since the refrigerator should be operated to keep the contents cold again at a lower temperature, there has been a problem in that consumption of electric power is further increased.

### SUMMARY OF THE INVENTION

Accordingly, the present invention is contemplated to solve the above problems in the prior art. An object of the present invention is to provide a vegetable box for a refrigerator wherein a small quantity of stored contents can be easily put into and taken out from the vegetable box without pulling the vegetable box as a whole.

Another object of the present invention is to provide a vegetable box for a refrigerator wherein a receiving space within the vegetable box can be partitioned into a number of small spaces while smooth flow of cold air can be still made between the partitioned receiving spaces.

According to an aspect of the present invention for accomplishing the object, there is provided a vegetable box for a refrigerator which comprises a box body formed with a receiving space in which stored contents are received, a receiving pocket made of flexible material and formed at a front end of the box body for defining an auxiliary receiving space, and a front door for forming a front surface of the box body and for opening and closing the auxiliary receiving space of the receiving pocket by its pivot action on hinge shafts at a lower portion of the box body

Preferably, one side of the receiving pocket is fixed to a support formed at an upper end of the box body, and the other side thereof is fixed to the front door.

Preferably, the receiving pocket has a plurality of vent holes or is manufactured of a net.

Preferably, the front door is selectively engaged to the support by a locking mechanism operated through a button provided at an upper end of the front door.

According to the vegetable box for the refrigerator of the present invention constructed as such, there are advantages in that a small quantity of stored contents can be conveniently put into and taken out from the vegetable box and cold air can be smoothly supplied into the vegetable box as a whole.

### BRIEF DESCRIPTION OF THE DRAWINGS

The above and other objects and features of the present invention will become apparent from the following description of preferred embodiments given in conjunction with the accompanying drawings, in which:

FIG. 1 is a perspective view of a conventional vegetable box for a refrigerator;

FIG. 2 is a perspective view of a vegetable box for a refrigerator according to a preferred embodiment of the present invention;

FIG. 3 is a partial sectional view of a major part of the vegetable box shown in FIG. 2;

FIG. 4 shows an operational state where a front door of the vegetable box of the present invention is opened;

FIG. 5 is a perspective view of a vegetable box for a refrigerator according to another preferred embodiment of the present invention; and

FIG. 6 is a partial sectional view of a major part of the vegetable box shown in FIG. 5.

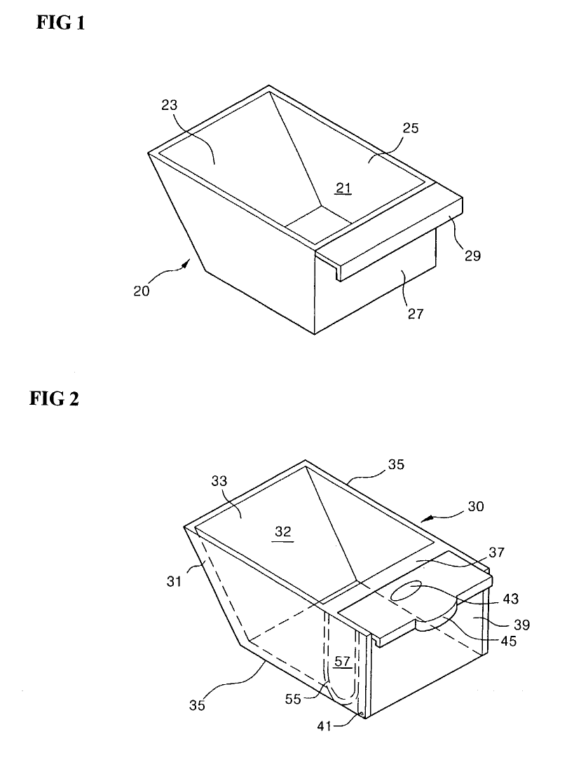

### DETAILED DESCRIPTION OF THE PREFERRED EMBODIMENTS

Hereinafter, a vegetable box for a refrigerator according to each of preferred embodiments of the present invention will be described in detail with reference to the accompanying drawings.

FIGS. 2 to 4 show a vegetable box according to a preferred embodiment of the present invention. As shown in the figures, a box body 31 forms a frame of the vegetable box 30. A receiving space 32 that is open at the top is formed within the box body 31.

The box body 31 takes an external appearance corresponding to a shape of the interior of a refrigerating chamber in which it is installed. For example, in a case where an inner surface of the refrigerating chamber corresponding to a rear surface 33 of the box body 31 is formed in an inclined state, the rear surface 33 is also formed correspondingly. Side surfaces of the box body 31 are generally formed to be perpendicular to a bottom surface of the refrigerating chamber.

Upper ends of the side surfaces 35 are formed with a support 37 at a position adjacent to a leading end of the box body 31. The support 37 is formed to extend in the right and left direction, as viewed in the front of the box body 31, to connect the upper ends of both the side surfaces 35 to each other.

A front door 39, which is constructed in an opening and shutting manner, forms a front surface of the box body 31. The front door 39 is provided with hinge shafts 41 at both lower ends thereof so that they can be rotatably engaged with hinge holes formed at lower ends of the side surfaces 35. The front door 39 rotates about the hinge shafts 41 to open and close the interior of the vegetable box 30.

The top of the front door 39 is provided with a locking mechanism including a button 43 for controlling opening and closing of the front door 39. A leading end of the front door 39 is formed with a handle 45 for allowing the vegetable box 30 to be easily pushed in and pulled out.

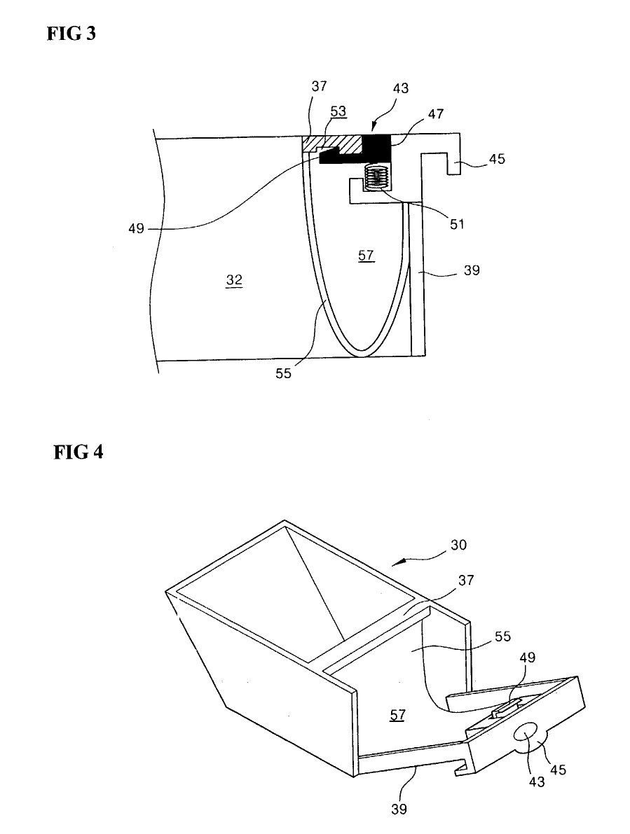

The locking mechanism comprises a body 47 of the button 43, a catching protrusion 49 formed horizontally in the body 47, a spring 51 for returning the button 43 to an original position after the button is pressed, and the like. Such a locking mechanism is well shown in FIG. 3.

In order to allow the front door 39 to be kept in a closed state by the locking mechanism, a catching groove 53 in which the catching protrusion 49 of the body 47 of the button 43 is caught is formed in the support 37.

A leading end of the vegetable box 30 is provided with a receiving pocket 55 capable of containing a small quantity of stored contents. The receiving pocket 55 defines an auxiliary receiving space 57. One side of the receiving pocket 55 is connected to the support 37, and the other side thereof is connected to an upper end of a rear surface of the front door 39.

Since the receiving pocket 55 consists of a part injection molded out of flexible material, the external appearance thereof may vary somewhat freely depending on stored contents to be stored in the auxiliary receiving space 57.

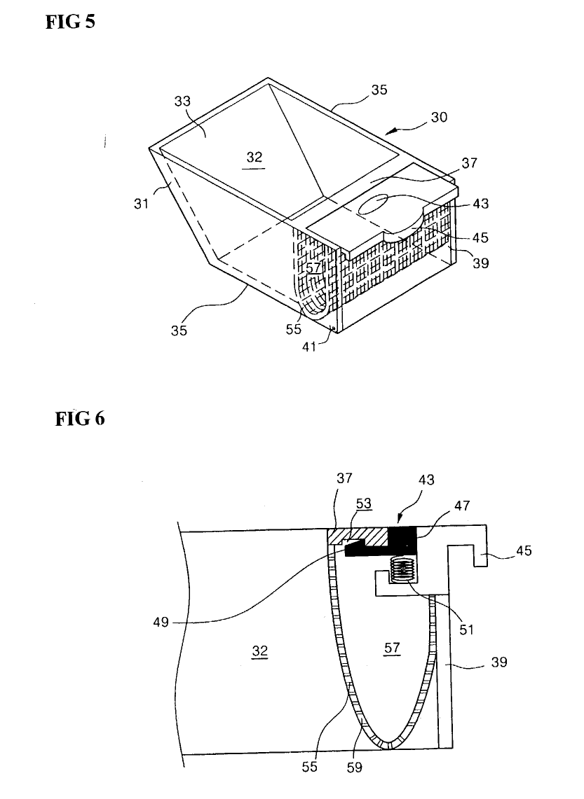

Meanwhile, another embodiment of the present invention is shown in FIGS. 5 and 6. In this embodiment, when compared with the aforementioned embodiment, in order to allow air to smoothly flow between the main receiving space 32 and the auxiliary receiving space 57, vent holes 59 are additionally formed in the receiving pocket 55.

The receiving pocket 55 is perforated so that the vent holes 59 are formed to take a lattice shape. In this case, the receiving pocket is injection molded out of flexible material. The receiving pocket 55 may be made of a net.

Now, an operation of the vegetable box for the refrigerator according to the present invention constructed as such will be described in detail.

First, for example, a case where a small quantity of foodstuffs is to be stored will be explained. A user first opens a door of the refrigerator in which the vegetable box 30 according to the present invention is installed. Next, while gripping the handle 45 in the front door 39 of the vegetable box 30 and pressing the button 43, the user pulls the handle 45 forward. By doing so, the front door 39 of the vegetable box 30 is inclined forward. This state is shown in FIG. 4.

That is, when the front door 39 rotates about the hinge shafts 41 formed at the lower ends thereof and is inclined forward, the front face of the vegetable box 30 becomes open. At this time, since the one side of the receiving pocket 55 is connected to the support 37 and the other side thereof is connected to the front door 39, the receiving pocket 55 is unfolded while following the front door 39. Thus, the auxiliary receiving space 57 of the receiving pocket 55 becomes open.

After the foodstuffs are put into the receiving pocket 55, the front door 39 is raised and pushed in. At this time, the catching protrusion 49 of the button 43 is slid on a bottom surface of the support 37 and goes into the catching groove 53 of the support 37, so that the front door 39 is locked.

One side of the catching protrusion 49 of the button 43 is constructed to be inclined. Accordingly, when the front door 39 is closed, the front door 39 is required to be simply pushed in without pressing the button 43. Then, the catching protrusion 49 is slid on the bottom surface of the support 37 and caught in the catching groove 43.

Next, an operation of storing a large quantity of stored contents will be described. When it is intended to pull the vegetable box 30, there is no need to press the button 43. Simply, the user grips the handle 45 and pulls it forward. At this time, since the catching protrusion 49 of the button 43 is caught in the catching groove 53 formed in the support 37, which is attached to the vegetable box 30, the entire vegetable box 30 is pulled out.

Subsequently, the stored contents can be put into or taken out from the receiving space 32 through the open top thereof. At this time, even though the stored contents are bulky, since the receiving pocket 55 is formed out of flexible material, they can be stored irrespective of the shape of the auxiliary receiving space 57 of the receiving pocket 55.

Meanwhile, in a case where the receiving pocket 55 is formed with the vent holes 59, air can flow between the main receiving space 32 and the auxiliary receiving space 57 through the vent holes 59. Accordingly, the temperature within the entire vegetable box 30 can be properly kept.

As described above, the vegetable box for the refrigerator according to the present invention comprises the additional receiving pocket and front door. Accordingly, when it is intended to store a small quantity of stored contents, there is no need to pull out the entire vegetable box, and only the front door may be opened by pressing the button so as to use the additional receiving pocket.

Accordingly, there is convenience of use in that only desired foodstuffs can be simply stored and taken out without requiring large force.

Further, when the foodstuffs contained in the receiving pocket is intended to be taken out, since there is no need to pull the entire vegetable box, external air does not come into direct contact with the stored contents placed at a rear portion of the receiving pocket.

Accordingly, there is less risk that the freshness of the foodstuffs may be deteriorated due to the contact with the external air. Further, the foodstuffs can be kept at a lower temperature. Consequently, it is expected to obtain an effect in that electric power required for operating the refrigerator to lower the temperature in the refrigerator raised due to exposure of the stored contents, which have been contained within the vegetable box, to the external air can be reduced.

Moreover, since air smoothly flows between the auxiliary receiving space formed within the receiving pocket and the main receiving space of the vegetable box by means of formation of the vent holes in the receiving pocket, the entire vegetable box can be kept at a uniform temperature.

As described above, it can be seen that it is a basic technical spirit that the vegetable box for the refrigerator according to the present invention includes the separate receiving pocket at the front portion thereof and the front door in front of the receiving pocket. It will be apparent to those skilled in the art that other various modifications may be made within the scope of this basic technical spirit of the present invention.

For example, in this embodiment, the button 43 is installed in the upper end of the door, and the door 39 is constructed to be opened by the pressing of the button 43. However, it may be constructed such that the front door 39 can be opened and closed by installing a catching protrusion or the like similar to the embodiment in the handle and then pulling the handle forward or moving the handle vertically.

Further, although the one side of the receiving pocket 55 is connected to the upper rear end of the front door 39 in this embodiment, it may be installed to be connected to the lower end of the front door 39 or the bottom end of the box body 30.

What is claimed is:

1. A vegetable box for a refrigerator, comprising:
a box body formed with a receiving space in which stored contents are received;
a receiving pocket made of flexible material and formed at a front end of the box body for defining an auxiliary receiving space; and
a front door for forming a front surface of the box body and for opening and closing the auxiliary receiving space of the receiving pocket by its pivot action on hinge shafts at a lower portion of the box body.

2. The vegetable box as claimed in claim 1, wherein one side of the receiving pocket is fixed to a support formed at an upper end of the box body, and the other side thereof is fixed to the front door.

3. The vegetable box as claimed in claim 2, wherein the receiving pocket has a plurality of vent holes.

4. The vegetable box as claimed in claim 2, wherein the receiving pocket is manufactured of a net.

5. The vegetable box as claimed in claim 1, wherein the front door is selectively engaged to the support by a locking mechanism which is operated through a button provided at an upper end of the front door.
